(19) United States
(12) Patent Application Publication
(10) Pub. No.: US 2008/0087443 A1
(43) Pub. Date: Apr. 17, 2008

(54) Hoof pick

(76) Inventor: Christina Jemail, Louisville, CO (US)

Correspondence Address: Christina Jemail, 2488 Evans Ave, Louisville, CO, 80027, US

(21) Appl. No.: 11/900,724

(22) Filed: Sep. 12, 2007

Related U.S. Application Data
(60) Provisional application No. 60/844,171, filed on Sep. 13, 2006.

(51) Int. Cl. A01L 11/00

(52) U.S. Cl. 168/48.1

(57) ABSTRACT

A hoof pick for cleaning debris from a horses hoof formed of a solid piece of metal having a handle end and a pick element which forms an angle such that the tip extends further than the handle at a downward angle between 95 and 120 degrees. The handle end is then overmolded with a material that provides a slight contour to the base metal handle to improve grip and comfort on the hand during use. The overmolded handle end also contains a hole which can be threaded with a rope or cord or placed on a hook for securing the hoof pick.

### CROSS-REFERENCE TO RELATED APPLICATIONS

This application claims a priority benefit under 35 U.S.C. ¶ 1119(e) to U.S. Provisional Patent Application No. 60/844,171 entitled “HOOF PICK” filed Sep. 13, 2006, each and every portion of the contents of which are incorporated herein by reference as if set forth herein.

### FIELD OF THE INVENTION

This invention relates to a hand held hoof pick for the removal of debris from an animal hoof, in particular an equine.

### BACKGROUND OF THE INVENTION

Hoof picks have been used for many years for the care and maintenance of animal hooves, and are particularly useful in equines. The hoof pick is used to clear debris that builds on the bottom and sides of the hoof and in particular the sole and frog of the hoof. By clearing the hoof of debris it also allows a means of visual inspection for any damage or injury to the hoof Daily cleaning is important as damage to the hoof can serve as a route of disease and infection in an equine such as horses, mules and donkeys. Thus, the hoof pick plays an important role in hoof maintenance and the overall health of the animal.

Typically, a hoof pick has two opposing ends, a handle end used to hold the hoof pick and a pick end used to remove the debris from the hoof Cleaning the hoof entails holding the hoof in one hand and with a hoof pick in the other hand digging out the debris from the hoof. In most circumstances when cleaning out the hoof, the handle is grasped so that the pick end of the hoof pick is pointed away from the person's body. However at times holding the hoof pick by the handle with the pick end facing the person is also useful. After grasping the handle a person first uses a downward motion of the wrist and then an upward motion engaging both the wrist and the elbow to provide the necessary force and leverage to remove the debris. A pulling motion can also be used. Even with daily cleaning it is generally agreed that effort and strength is required of the user. If the hoof is not cleaned regularly debris can become impacted in such a way that a great deal of force is needed to remove the debris with a hoof pick. The force necessary to clean the hoof may exceed the strength of the hoof pick causing it to bend and sometimes break. If the hoof pick used cannot remove the debris from the hoof, sometimes stronger and heavier devices such as screw drivers and/or rasps are used to remove the debris. Devices of this nature can pose a danger not only to the animal but also to the individual cleaning the hoof as well.

The majority of hoof picks on the market today are based on a design that has been used for years. Many are manufactured in pieces so the tip end is either welded or pressed onto the handle. This type of pick design generally is not very strong and with constant use tends to bend and dull over time, rendering the hoof pick ineffective. The hoof picks of this design though relatively inexpensive must be replaced frequently. Most hoof picks of the prior art have a short pick length, which impedes the cleaning of hooves of horses with larger feet, deeper soles or those wearing thicker shoes. The shorter pick length results in more time and energy spent cleaning out a single hoof. Furthermore, acute pick angles of the prior art are 90 degrees or less which require more leverage and strength to remove the debris from the hoof. The hoof pick of the present invention solves these problems. Descriptions of prior art hoof picks and uses can be found in a number of U.S. patents.

U.S. Pat. No. 5,176,222 to Tippin (1993) discloses a hand held tool for the cleaning of horse' hooves with a hoof pick pivotally attached to one end of a handle. The hoof pick when adjacent to the handle forms an open area for attachment to the belt tool or belt of a person. A retainer restrains the hoof pick in both the open and closed positions and a lock device acting on the retainer prevents movement of the hoof pick.

U.S. Pat. No. 5,636,697 to Pitchford (1995) discloses a hand held tool for cleaning hooves wherein a pick member is formed at the first end of a handle and a blade is integrally formed at the second end, wherein said pick member is perpendicular to the handle.

U.S. Pat. No. 5,575,337 to Sapyta (1996) discloses a hand held hoof pick for cleaning horse' hooves having a T-shaped handle having an elongated shank with a wedged-shaped tip forming an angle between the longitudinal axis of the shank and the angle of the tip greater than 0 degrees and less than 90 degrees.

U.S. Pat. No. 6,176,319 to Ehrmann (2001) discloses a hand held tool for cleaning horses' hooves having a shaped handle and a bent metal pick element oriented so that an acute picking angle having a range from 15 to 35 degrees. The improved picking angle allows highly controllable and effective leveraged in cleaning.

Additional teachings can be found in U.S. Pat. No. D443,396 to Bison (2000), U.S. Pat. No. D448,572 to Gravlee (2001) and U.S. Pat. No. D444,272 to Bereuter 2001.

The hand held hoof pick of the present invention provides an improved hoof pick having a solid metal configuration with a pick angle greater than 90 degrees, a heat-treated tip, and an overmolded handle resulting in greater efficiency, ease and comfort when cleaning out the debris from a hoof.

### SUMMARY OF THE INVENTION

The present invention is drawn to an improved hoof pick that is made from a solid piece of metal having a handle and pick element integral with one end of the handle for the cleaning of debris from the hoof of an equine.

One aspect of the present invention is the pick element of the hoof pick is oriented at an angle between 95 and 120 degrees to the longitudinal axis of the handle. This increased picking angle results in less wrist movement and less torque on the arm of the user.

Another aspect of the present invention is the handle is overmolded and configured to fit comfortably in the hand of the user.

Another aspect of the present invention is a heat-treated tapered tip that is at the end of the pick, the tip is heat-treated for increased strength and the end is tapered and pressed to enable easier cleaning of the hoof with a pick tip that focuses the pressure applied to the pick during cleaning.

### BRIEF DESCRIPTION OF THE DRAWINGS

FIG. 1 (a) depicts a cross-sectional view of the solid metal base metal design of the hoof pick with the associated specifications.

FIG. 1 (b) depicts an overhead view of the solid metal base design of the hoof pick with hole specifications.

FIG. 1 (c) depicts the width of the tapered tip of the pick element.

FIG. 2 depicts a view of the present invention.

FIG. 3 depicts the overmolded handle and associated specifications.

### DETAILED DESCRIPTION OF THE INVENTION

The hand held hoof pick of the present invention is formed of a solid piece of metal having a handle 20 and a pick element 26 that is integral at a first end of the handle, for added comfort the handle end is overmolded with a material such as a plastic, rubber or polymer. The overmolded handle end is shaped to provide a contoured surface for improved hand placement, grip and comfort on the hand during use.

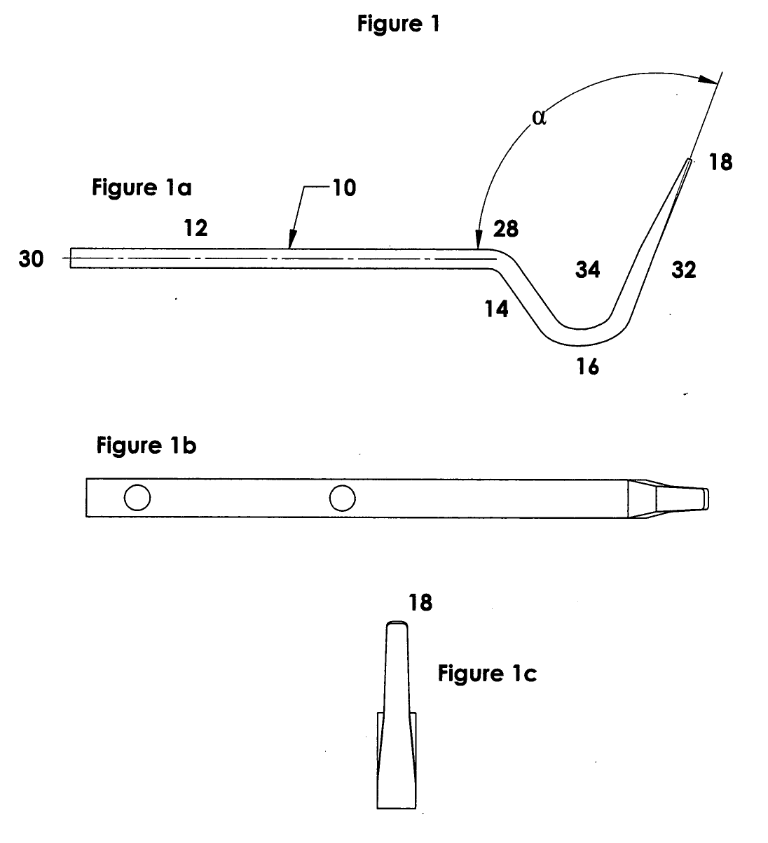

The hoof pick of the present invention is formed of a solid piece of metal, both the handle and pick element are formed from a continuous piece of metal thus the hoof pick will be inherently stronger than hoof picks that are pieced, jointed or welded together. This is an improvement over hoof picks in which a picking element is embedded into a wooden, plastic or other handle. The solid piece of metal that forms the hoof pick is selected from metals such as stainless steel, low carbon steel or titanium; this selection not to be limiting. The hoof pick of the present invention may be forged, cast, molded, stamped or coined. In the present invention stainless steel is a preferred embodiment. The hoof pick of the present invention can be made from any one of these metals and can handle stresses ranging from 25-50 lbs per square inch (psi) depending on the type of metal used. Being crafted out of a single piece of quality metal and able to handle the stress conditions previously mentioned, the hoof pick will not bend or break with constant use. The hoof pick is also heat-treated adding to the strength. Heat-treating is known to triple the strength of stainless steel. The metal base of the hoof pick of the present invention is shown in FIG. 1a. The metal base of the hoof pick 10 of the present invention measures between 5 and 7 inches in total length. In a preferred embodiment the total length of the metal base of the hoof pick is about 6 inches long. The thickness of the hoof pick ranges from 0.15 to 0.25 inches with 0.19 inches being the preferred thickness. This thickness is maintained throughout the length of the hoof pick only to decrease in thickness with the taper at the tip of the pick element. The widths of the hoof pick ranges from 0.30 to 0.50 with a preferred embodiment of 0.38 inches. In another embodiment two holes are placed in the handle end of the hoof pick these holes are used to secure the overmolding material. The holes are placed in the handle end of the hoof pick at about 0.50 inches and about 2.50 inches from the end of the handle as illustrated in FIG. 1b.

The elongated handle 12 measures between 3 and 5 inches in total length with a preferred length of 4.08 inches. In a preferred embodiment of the present invention the handle 12 of the present invention is straight and longitudinally oriented around a first axis 30.

The pick element is integral at a first end of the handle 28 where the metal base of the handle transitions from its original longitudinal axis 30 and forms a first region 14 which is swept posterior to form a bend region 16 from which a second region 32 extends away from the handle and tapers to form a tip on the pick element 18. The bend region has a midpoint 34. The preferred length of the first region 14 is about 1.08 inches from the first end of handle 28 to the midpoint of the bend region 34. The second region 32 is of a length that extends past the longitudinal axis of the handle end 30. The preferred length of the second region 32 is about 1.07 inches measured from the midpoint of bend region 34 to the tip of the pick element 18. An acute angle α is formed between the tip of the pick element 18 and the longitudinal axis of the handle 30. The angle created provides the pick with a slightly outward pointing tip at the pick element 18. An acute picking angle is formed from the longitudinal axis of the handle 30 to the tip of the pick element 18. This angle is between 95 and 120 degrees and more preferably of 110 degrees. The acute pick angle of the present invention allows for improved leverage and ease of use of the present invention as compared to the prior art. The second region 32 tapers to the tip of the pick element 18. The length of the second region extends outwardly beyond the longitudinal axis of the handle and tapers to form a tip on the pick element. The tip of the pick element 18 has smooth squared edges and is approximately 0.2 inches wide see FIG. 1c; with a thickness of 0.05 inches see FIG. 1b. The tip of the pick 18 is pressed to increase the strength and integrity of the hoof pick. The hoof pick 10 can be of varying lengths, as long as the acute picking angle is retained. The combination of the tapered tip of the pick element, the acute picking angle and strength of the solid metal hoof pick make the present invention much easier on the person cleaning the debris from the hoof. It is important that the edges and surfaces on the tip of the pick element be smooth so as to avoid any injury to the horses' hoof during use. In most cases a pivot of the wrist is enough to dislodge the debris resulting in a clean hoof, however if debris is more firmly lodged in the hoof, gentle pushing and pulling of the debris will clean the hoof without undue exertion by the person cleaning the hoof. It is realized that the hoof pick of the present invention could easily be utilized without the overmolded handle however, the overmolded handle is an improvement that provides comfort for the user.

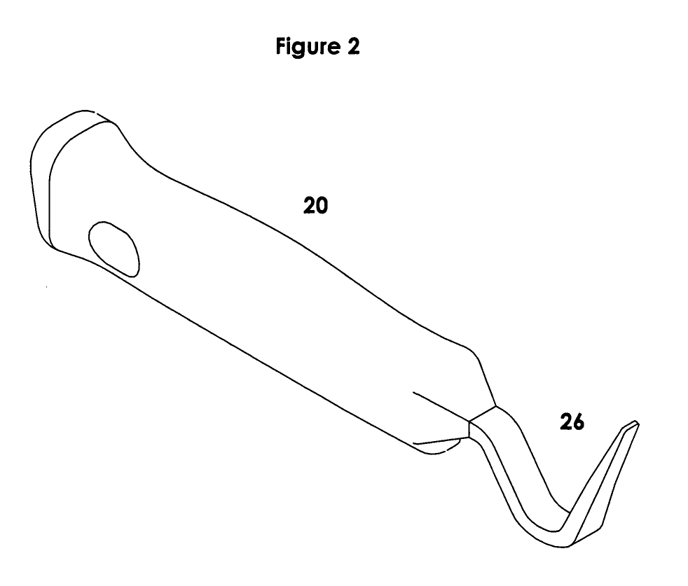

FIG. 2 is a perspective view of the hoof pick tool showing the overmolded handle and the pick element. The hand held hoof pick of the present invention is formed of a solid piece of metal having a handle 20 and a pick element 26 that is integral at a first end of the handle, for added comfort the handle end is overmolded with a material such as a plastic, rubber or polymer. The overmolded handle end is shaped to provide a contoured surface for improved hand placement, grip and comfort on the hand during use.

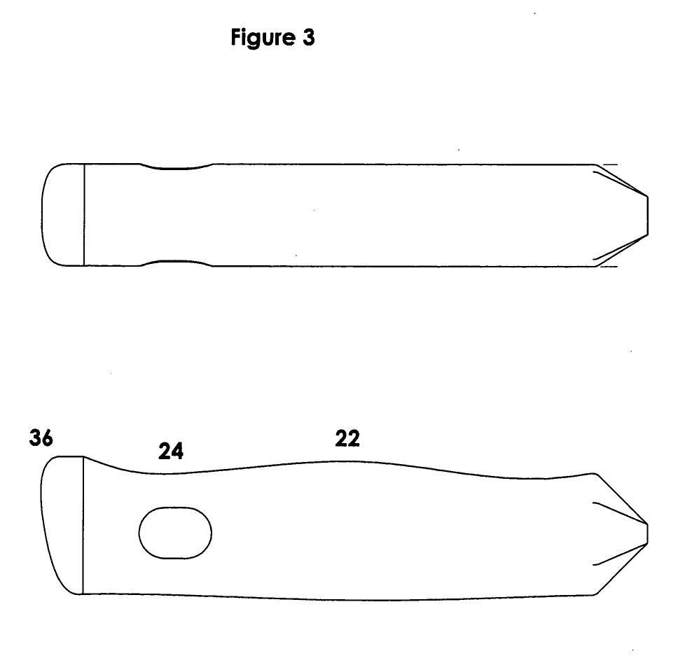

The overmolded handle 20 of FIG. 3 can be made of materials such as plastics, rubbers or polymers. The materials can be used alone or in combination to achieve the overmolded handle of choice. In a preferred embodiment polypropylene and thermoplastic rubber is used for the overmolded handle of the present invention. The handle of the metal base of the hoof pick is overmolded with the material to provide a comfortable hand placement and position for the user allowing for reduced pressure on the contact points of the hand when cleaning out the hoof. The length of the overmolding ranges from 4-6 inches on the handle section of the base metal hoof pick. In a preferred embodiment the overmolded handle extends beyond the metal base of the hoof pick resulting in more surface area for users with larger hands and the ability to place a hole in the distal end of the overmolded handle without affecting the integrity of the solid metal base of the hoof pick. The overmolded handle can be approximately the same diameter for the entire length of the handle. In a preferred embodiment the overmolded handle has a slight contour with an increase in diameter at the middle of the handle 22, the diameter then decreases and extends to a flared end. The handle allows for different size hands to maintain a comfortable position and feel. The diameter ranges from 1.0 to 1.5 inches with an ideal range of 1.2 to 1.4 inches. The contour of about 0.39 inches of the over molded handle increases leverage, reduces stress on wrists and palms making it easier when using either a pushing or pulling motion when cleaning out the hoof. The overmolded handle also has a hole 24 in the distal end 36 which can be used for securing the hoof pick. The hole is made in the overmolded material beyond the base metal pick. The hole shape is oval to provide for a variety of ropes, cords or hooks that will fit into it. The hoof pick of the present invention could be placed on a hook next to a stall by utilizing the oval hole in the overmolded handle or attached to a fix object by rope or cord. The hoof pick is designed to be grasped comfortably by a variety of hand sizes and shapes. It is intended that the overmolded handle be grasped so that the fingers surround the handle and the thumb gently rests adjacent to the index finger. The pick element ideally is facing away from the users body however, the overmolded handle may be grasped so that the pick element is facing toward the users body. Small pivot movements of the wrist should be all that is necessary for removal of debris from the hoof using the hoof pick of the present invention. The overmolded handle has been designed so that it will fit equally well in either a left-handed or right-handed person. Furthermore, the hoof pick of the present invention can also be envisioned to have a brush end or a knife end added to it. For example, a brush end would provide a mechanism to brush any remaining debris from the hoof and a knife end would allow for removal of sloughed hoof in the case of a horse with thrush.

Furthermore, the description of the invention has been presented for purposes of illustration and description. Moreover, the description is not intended to limit the variations and modifications commensurate with the above teachings, and the skill or knowledge in the relevant art are within the scope of the present invention. It will be apparent to those skilled in the art that various modifications and variations can be made in the methods and compositions of the present invention without departing from the spirit or scope of the present invention, and thus it is intended that the present invention cover modifications and variations of this invention provided they come within the scope of the appended claims and their equivalents. Also, the preferred embodiment(s) described hereinabove are intended to explain the best mode known of practicing the invention and to enable others skilled in the art to utilize the invention in various embodiments and with the various modifications required by their particular applications or uses of the invention. It is intended that the appended claims be construed to include alternate embodiments to the extent permitted by the prior art.

I claim:

1. A hand held tool for cleaning the hooves of an equine comprising:
an elongated handle having a longitudinal axis, said handle having a first end;
a pick element integral to said first end;
said pick element having a first region and a second region, said first region connected to said first end of said handle and said second region connected to said first region by a bend region, said second region extending to an end portion having a tapered tip;
said bend region forms an acute angle between said handle longitudinal axis and said tip of pick element that is between 95 and 120 degrees; and
wherein said elongated handle is overmolded with a material for ease and comfort in the clearing of debris.

2. The tool of claim 1, wherein the acute pick angle is 110 degrees.

3. The tool of claim 1, wherein the overmolded handle is made of polypropylene and thermoplastic rubber.

4. The tool of claim 1, wherein the tool is made of a solid piece of metal.

5. The tool of claim 1 where the tool is heat-treated.

6. The tool of claim 1 wherein the elongated handle has holes to affix the material.

7. The tool of claim 1, wherein the overmolded handle is shaped to fit comfortably in the users hand.

8. The tool of claim 1, wherein the tip of the pick element has smooth squared edges and is about 0.2 inches wide and has a thickness of about 0.05 inches.

9. The tool of claim 1, wherein said second region is about 1.07 inches long and extends outwardly beyond the longitudinal axis of said handle.
